(19) United States
(12) Patent Application Publication
(10) Pub. No.: US 2023/0273546 A1
(43) Pub. Date: Aug. 31, 2023

(54) TONER CARTRIDGE HAVING FRONT COVER

(71) Applicant: Hewlett-Packard Development Company, L.P., Spring, TX (US)

(72) Inventors: Youngkwang SHIN, Seongnam-si (KR); Seungchan PARK, Seongnam-si (KR); Donguk KIM, Seongnam-si (KR); Jinsam PARK, Seongnam-si (KR)

(73) Assignee: Hewlett-Packard Development Company, L.P., Spring, TX (US)

(21) Appl. No.: 18/016,524

(22) PCT Filed: Nov. 11, 2020
(86) PCT No.: PCT/US2020/059966

§ 371 Date: Jan. 17, 2023

(30) Foreign Application Priority Data
Jul. 17, 2020 (KR) 10-2020-0088639

(51) Int. Cl. G03G 15/08

(52) U.S. Cl. CPC G03G 15/0872; G03G 15/0886; G03G 2215/0692

(57) ABSTRACT

A toner cartridge includes a housing to contain toner and comprising a toner outlet adjacent to a front end in a longitudinal direction; a front cover coupled to the front end of the housing; a first coupling portion to couple the front cover to the housing based on a coupling force of the first coupling portion; and a shutter movable between an open position and a closed position to open and close the toner outlet, and to weaken the elastic coupling force of the first coupling portion when the shutter is moved from the closed position to the open position.

### BACKGROUND

Image forming apparatuses using an electrophotographic method supply toner to an electrostatic latent image formed on a photoconductor to form a visible toner image on the photoconductor, transfer the visible toner image to a print medium directly or via an intermediate transfer medium, and then fix the transferred visible toner image on the print medium.

Image forming apparatuses may include a toner cartridge that is attachable/detachable to/from a main body. Toner cartridges are replaced when their service life has expired. When toner contained inside a toner cartridge is consumed, the toner cartridge may be removed from the main body, and a new toner cartridge may be mounted in the main body.

### BRIEF DESCRIPTION OF THE DRAWINGS

FIG. 1 is a partially exploded perspective view of an example of a toner cartridge.

FIG. 2 is a schematic bottom view of the example of the toner cartridge shown in FIG. 1 and shows a state where a shutter is in a closed position.

FIG. 3 is a schematic bottom view of the example of the toner cartridge shown in FIG. 1 and shows a state where the shutter is located in an open position.

FIG. 4 is a perspective view of an example of a toner cartridge attached/detached to/from a main body of an image forming apparatus.

FIG. 5 is a partially exploded perspective view of an example of a locking structure.

FIG. 6 is a schematic partial perspective view of an example of a toner cartridge.

FIG. 7 is a detailed view of an example of a second coupling portion shown in FIG. 6.

FIG. 8 is a plan view of a front cover separated from a housing in an example of the toner cartridge shown in FIG. 6.

### DETAILED DESCRIPTION

An image forming apparatus to print an image on a print medium by an electrophotographic method may include a replaceable toner cartridge. A developer is contained in the toner cartridge. The developer may include toner and may also include toner and carrier. To prevent random replacement of the toner cartridge, the toner cartridge is locked in a main body when the toner cartridge is mounted on the main body of the image forming apparatus. When a user inputs a toner cartridge replacement command through an input device of the image forming apparatus or through a host connected to the image forming apparatus, the toner cartridge is unlocked and is in a removable state from the main body. However, when the user pulls the toner cartridge in a removal direction to randomly remove the toner cartridge while the toner cartridge is locked in the main body, a locking device may be broken.

The toner cartridge of the present example includes a housing in which toner is contained, and a front cover coupled to a front portion of the housing, for example, an end of the housing in a removal direction. The front cover is elastically coupled to the housing by a coupling portion. The housing is provided with a toner outlet. A shutter is supported on the housing such that the shutter may be moved to an open position and a closed position to open and close the toner outlet. When the toner cartridge is mounted in a main body, the shutter is moved to the open position. The shutter weakens (or decreases) the elastic coupling force of the front cover while being moved to the open position. In the above state, when the toner cartridge is pulled in a removal direction while holding the front cover of the toner cartridge, the front cover is separated from the housing of the toner cartridge. Therefore, the housing of the toner cartridge may be maintained locked to the main body, and the locking device may be prevented from being broken. Also, arbitrary replacement of the toner cartridge may be prevented. Hereinafter, examples of a toner cartridge will be described with reference to the drawings. In the drawings, like reference numerals refer to like elements having like functions, and the size of each element may be exaggerated for clarity and convenience of the description.

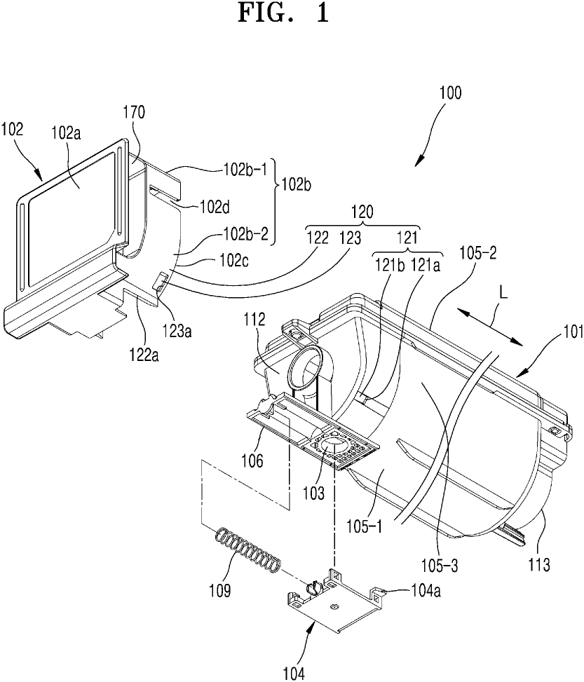

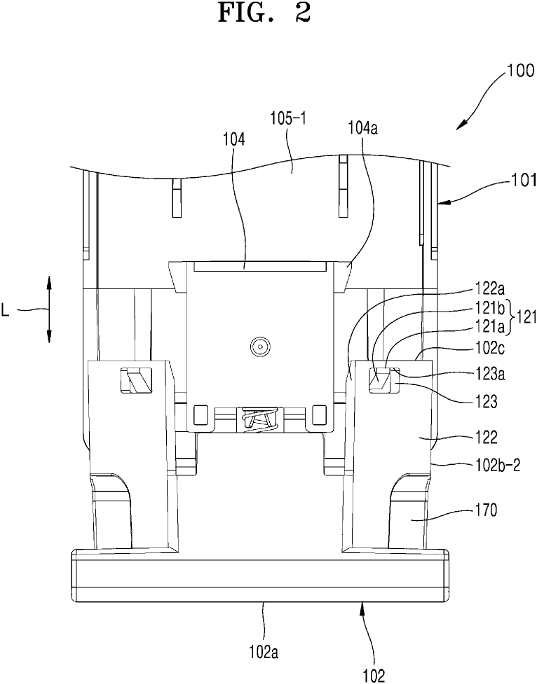

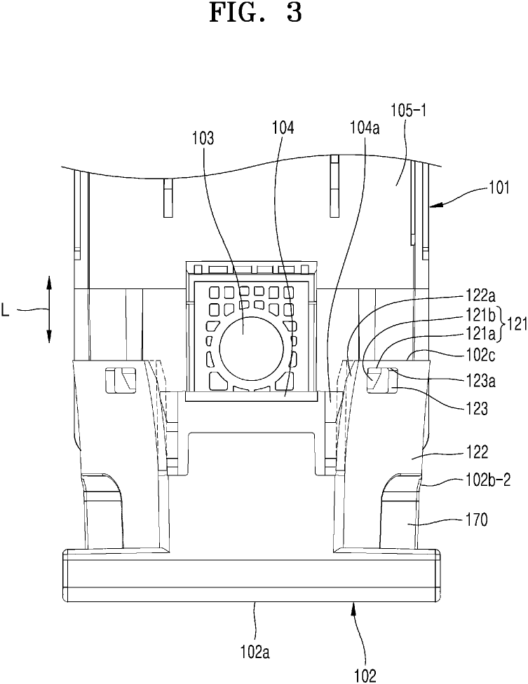

FIG. 1 is a partially exploded perspective view of an example of a toner cartridge 100. FIGS. 2 and 3 are schematic bottom views of the example of the toner cartridge 100 shown in FIG. 1. FIG. 2 shows a state where a shutter 104 is in a closed position, and FIG. 3 shows a state where the shutter 104 is in an open position.

Referring to FIGS. 1 to 3, the example of the toner cartridge 100 may include a housing 101 which contains toner and includes a toner outlet 103 adjacent to a front end 112 in a longitudinal direction L, a front cover 102 which is elastically coupled to the front end 112 of the housing 101, and the shutter 104 which is movable to the open position and the closed position that opens and closes the toner outlet 103, and, when moving from the closed position to the open position, weakens the elastic coupling force of the front cover 102. The housing 101 and the front cover 102 may be elastically coupled by a first coupling portion 120. When the shutter 104 is moved from the closed position to the open position, the shutter 104 may weaken the coupling force of the first coupling portion 120.

The housing 101 may have a cylindrical shape extending in the longitudinal direction L to contain toner therein. The housing 101 has the front end 112 and a rear end 113 opposite to the front end 112 in the longitudinal direction L. The housing 101 may include a lower wall 105-1, an upper wall 105-2, and a side wall 105-3 connecting the lower wall 105-1 to the upper wall 105-2. The lower wall 105-1 may have a round shape. The toner outlet 103 may be adjacent to any one of the both ends, that is, the front and rear ends 112 and 113, of the housing 101 in the longitudinal direction L. In the present example, the toner outlet 103 is adjacent to the front end 112 of the housing 101. The toner inside the housing 101 is conveyed to the toner outlet 103 by a transport member (not shown). The toner outlet 103 may be formed on the lower wall 105-1 of the housing 101 such that the toner may be naturally discharged to the outside of the toner cartridge 100 through the toner outlet 103 by gravity.

The front cover 102 is coupled to the front end 112 of the housing 101. The front cover 102 may include a front wall 102a facing the front end 112 of the housing 101 and a side wall 102b extending from the front wall 102a toward the front end 112 of the housing 101. The side wall 102b may be provided with a handle 170. The handle 170 may be formed by being sunken inward from the side wall 102b. The side wall 102b may include a first side wall 102b-1 located in the vertical direction, that is, on the opposite side of the lower wall 105-1 of the housing 101, and a second side wall 102b-2 on a traverse direction (such as a horizontal direction) side. The handle 170 may be formed by being sunken in the second side wall 102b-2. The side wall 102b of the front cover 102 may enclose the front end 112 of the housing 101 as a whole. The first side wall 102b-1 of the front cover 102 faces the upper wall 105-2 of the housing 101, and the second side wall 102b-2 of the front cover 102 faces the side wall 105-3 and the lower wall 105-1 of the housing 101.

The first coupling portion 120 elastically couples the housing 101 to the front cover 102. The first coupling portion 120 of the present example may have a snap-fit structure in which the front cover 102 is elastically coupled to the housing 101. According to an example, the first coupling portion 120 may include a first elastic arm 122 provided on the front cover 102, a first coupling protrusion 121 provided on one of the housing 101 and the first elastic arm 122 and a first locking groove 123 provided on the other one of the housing 101 and the first elastic arm 122 such that the first coupling protrusion 121 is locked. When the shutter 104 is moved from the closed position to the open position, the shutter 104 may interfere with the first elastic arm 122 to deform the first elastic arm 122 in a direction in which an amount of locking between the first coupling protrusion 121 and the first locking groove 123 decreases. In the present example, the first coupling protrusion 121 is provided on the housing 101, and the first locking groove 123 is provided in the first elastic arm 122.

The first coupling protrusion 121 may be formed on a position adjacent to the front end 112 of the housing 101. According to an example, the first coupling protrusion 121 may include a protruding end 121a protruding from the lower wall 105-1 of the housing 101, and an inclined portion 121b having an amount of protrusion decreasing toward the front cover 102 from the protruding end 121a. According to an example, the first elastic arm 122 may extend from the front wall 102a of the front cover 102 toward the front end 112 of the housing 101. For example, a first cut groove 102d that extends and cut from the end 102c toward the front wall 102a may be provided in the second side wall 102b-2. A part of the second side wall 102b-2 distinguished from the first side wall 102b-1 by the first cut groove 102d may function as the first elastic arm 122. The first locking groove 123 may be formed through the first elastic arm 122.

In order to couple the front cover 102 to the front end 112 of the housing 101, when the first coupling protrusion 121 is aligned with the first locking groove 123 to push the front cover 102 toward the front end 112 of the housing 101, the end 102c of the first elastic arm 122 is in contact with the inclined portion 121b of the first coupling protrusion 121. When the front cover 102 is further pushed in this state, the first elastic arm 122 is opened to the outside. When an edge 123a of the housing 101 of the first locking groove 123 reaches the protruding end 121a of the first coupling protrusion 121, the first elastic arm 122 elastically retracts and the first coupling protrusion 121 is inserted into the first locking groove 123. The edge 123a of the first locking groove 123 is locked by the protruding end 121a of the first coupling protrusion 121, and as shown in FIG. 2, the front cover 102 is elastically coupled to the front end 112 of the housing 101. Because the edge 123a of the first locking groove 123 is locked by the protruding end 121a of the first coupling protrusion 121, even if the front cover 102 is pulled in the longitudinal direction L, the front cover 102 is not separated from the housing 101.

The shutter 104 is supported on the housing 101 such that the shutter 104 may be switched to an open position (FIG. 3) and a closed position (FIG. 2) to open and close the toner outlet 103. According to an example, the shutter 104 may be moved in the longitudinal direction L and switched to the open position and the closed position. A rail 106 extending in the longitudinal direction L may be provided on the housing 101. The shutter 104 may be supported on the rail 106 and be movable to the open position and the closed position. An elastic member 109 provides the shutter 104 with an elastic force in a direction located in the closed position. According to an example, the elastic member 109 may be a compression coil spring having one end and the other end respectively supported on the shutter 104 and the rail 106. The shutter 104 weakens (or decreases) the elastic coupling force of the front cover 102 when moved from the closed position to the open position. According to an example, when the shutter 104 is moved from the closed position to the open position, the shutter 104 may interfere with the first elastic arm 122 to deform the first elastic arm 122 in the direction in which the amount of locking between the first coupling protrusion 121 and the first locking groove 123 decreases.

According to an example, a first interference portion 122a may be provided on the first elastic arm 122. A second interference portion 104a that interferes with the first interference portion 22a as the shutter 104 moves to the open position may be provided on the shutter 104. The first interference portion 122a may be provided on an edge adjacent to the toner outlet 103 of the first elastic arm 122 and may extend in the longitudinal direction L. The second interference portion 104a may have a shape protruding from the shutter 104 in a transverse direction, that is, a direction orthogonal to the longitudinal direction L. The second interference portion 104a may have a shape in which an amount of interference with the first interference portion 122a gradually increases as the shutter 104 is moved to the open position. For example, the amount of protrusion of the second interference portion 104a in the transverse direction may be the greatest at an end far from the front cover 102 and decrease toward an end adjacent to the front cover 102. Alternatively, the first interference portion 122a may have a shape in which the amount of interference with the second interference portion 104a gradually increases as the shutter 104 is moved to the open position. For example, the amount of protrusion of the first interference portion 122a in the transverse direction may be the greatest at an end adjacent to the front cover 102 and decrease toward an end far from the front cover 102.

Referring to FIG. 3, as the shutter 104 is moved from the closed position to the open position, the second interference portion 104a interferes with the first interference portion 122a and pushes the first elastic arm 122 in the transverse direction. Then, while the first elastic arm 122 is elastically opened to the outside, the first elastic arm 122 is spaced apart from the lower wall 105-1 of the housing 101, and the amount of locking between the first coupling protrusion 121 and the first locking groove 123 decreases. Even when the shutter 104 reaches the open position, the first interference portion 122a and the second interference portion 104a remain in contact with each other, and the first elastic arm 122 is maintained in a position where the amount of locking between the first coupling protrusion 121 and the first locking groove 123 decreases. In this state, when the front cover 102 is pulled in the longitudinal direction L, the first coupling protrusion 121 may be detached from the first locking groove 123 such that the front cover 102 may be separated from the housing 101. Although not shown in the drawing, when the shutter 104 reaches the open position, the first coupling protrusion 121 may be unlocked from the first locking groove 123.

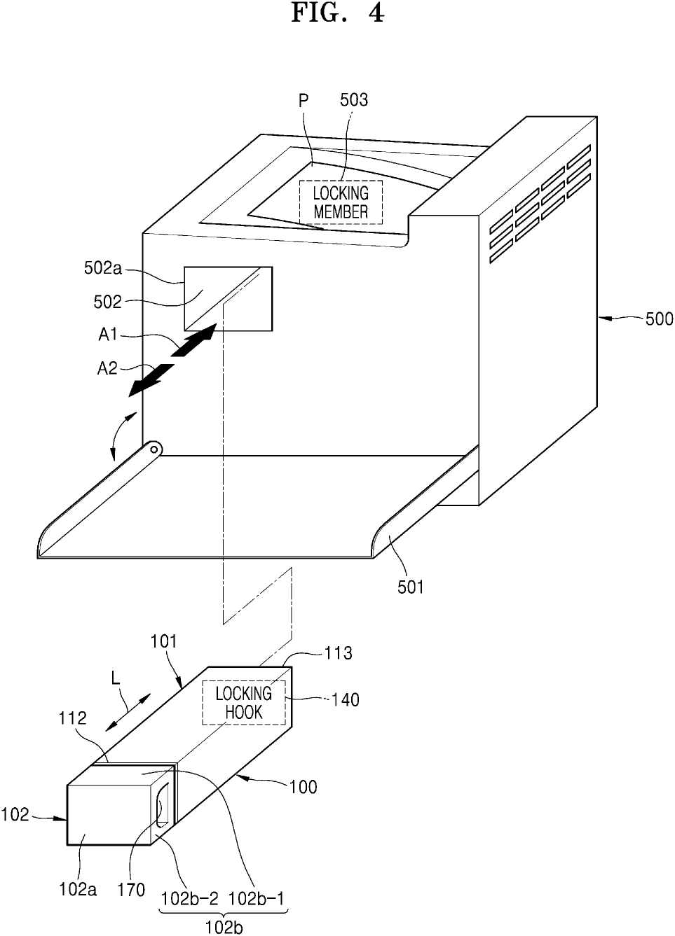

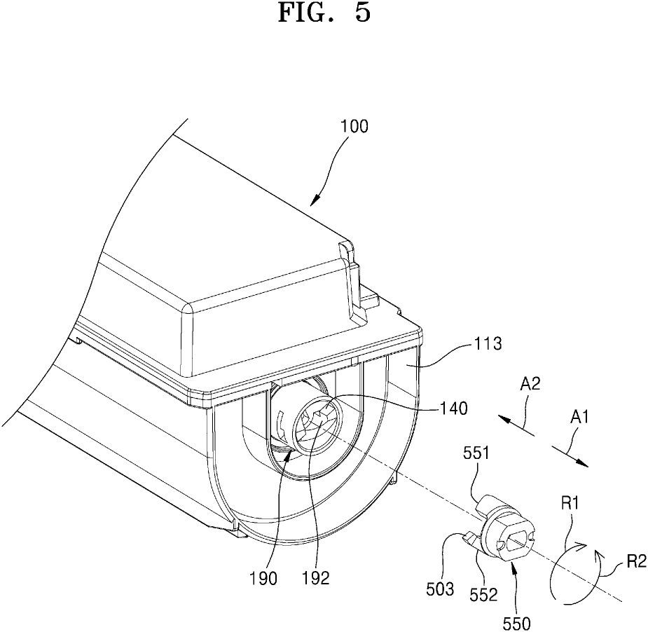

FIG. 4 is a perspective view of an example of the toner cartridge 100 attached/detached to/from a main body 500 of an image forming apparatus. FIG. 5 is a partially exploded perspective view of an example of a locking structure. Referring to FIGS. 4 and 5, the image forming apparatus may include the main body 500 and a toner cartridge 100 attachable/detachable to/from the main body 500. The main body 500 may include a printing portion that prints an image on a print medium P by using an electrophotographic method. Toner to be supplied to the main body 500 is contained in the toner cartridge 100.

According to an example, the printing portion may include an optical scanner, a developing device, a transfer unit, and a fuser, The developing device may include a photosensitive drum and a developing roller The optical scanner forms an electrostatic latent image by irradiating light corresponding to image information on a surface of the photosensitive drum charged with a uniform surface electric potential. The developing roller supplies toner contained in the developing device to the electrostatic latent image to develop the electrostatic latent image into a visible toner image. The transfer unit transfers, to the print medium P, the toner image formed on the photosensitive drum. The toner image transferred to the print medium P remains attached to the print medium P by an electrostatic force. When the print medium P passes through the fuser, the toner image is fixed to the print medium P by heat and pressure. The print medium P, on which printing is completed, is discharged to the outside of the main body 500.

The toner cartridge 100 may be connected to the developing device to supply toner to the developing device. The toner cartridge 100 is detachably attached to the image forming apparatus. A mounting portion 502 is provided on the main body 500. When a door 501 is opened to open a part of the main body 500, an entrance 502a of the mounting portion 502 is exposed. The toner cartridge 100 may be mounted on the main body 500 by aligning the toner cartridge 100 with the entrance 502a of the mounting portion 502 and sliding the toner cartridge 100 in a mounting direction A1. Also, the toner cartridge 100 may be removed from the main body 500 by sliding in a removal direction A2. The mounting direction A1 and the removal direction A2 may be a longitudinal direction L of the toner cartridge 100.

The shutter 104 is in a closed position by the elastic force of the elastic member 109 while the toner cartridge 100 is separated from the main body 500. The shutter 104 may be switched from the closed position to close the toner outlet 103 to an open position to open the toner outlet 103 in conjunction with an operation in which the toner cartridge 100 is mounted on the mounting portion 502. For example, when the toner cartridge 100 is inserted into the mounting portion 502 and approaches a mounting position, the shutter 104 may interfere with an opening member (not shown) provided in the mounting portion 502 to be switched from the closed position to the open position. When the toner cartridge 100 is removed from the mounting portion 502, the shutter 104 may be returned from the open position to the closed position by the elastic force of the elastic member 109. According to another example, when the toner cartridge 100 is inserted into the mounting portion 502 and reaches the mounting position, the shutter 104 may be switched from the closed position to the open position by a driving means provided in the toner cartridge 100 or the main body 500.

When the toner cartridge 100 is mounted on the main body 500, the toner cartridge 100 is connected to a motor (not shown) provided in the main body 500 by a coupling structure, and receives rotation power from the motor such that a rotation member included in the toner cartridge 100 rotates. The rotation member may include, for example, one or more transporting members that transport toner inside the toner cartridge 100 to the toner outlet 103. The coupling structure may include a driving coupler 550 provided in the main body 500 and a driven coupler 190 provided in the toner cartridge 100. The driving coupler 550 may include a rotation power transmitting portion 552. The driven coupler 190 may include a rotation power receiving portion 192 that receives the rotation power from the rotation power transmitting portion 552. When the toner cartridge 100 is mounted on the mounting portion 502 of the main body 500, the rotation power transmitting portion 552 and the rotation power receiving portion 192 face each other in a rotation direction. When the driving coupler 550 rotates in a first rotation direction R1, the rotation power transmitting portion 552 pushes the rotation power receiving portion 192 in the first rotation direction R1 . Therefore, the driven coupler 190 rotates in the first rotation direction R1.

The toner cartridge 100 may be locked to the main body 500 by the locking structure. The locking structure may include a locking member 503 provided on the main body 500 and a locking hook 140 provided on the toner cartridge 100. When the toner cartridge 100 is mounted on the main body 500, the locking member 503 is locked by the locking hook 140 to lock the toner cartridge 100 so as not to be removed. According to an example, the locking member 503 and the locking hook 140 may be provided on the driving coupler 550 and the driven coupler 190, respectively. The locking member 503 may extend from the rotation power transmitting portion 552 in a circumferential direction. The locking hook 140 may extend from the rotation power receiving portion 192 in the circumferential direction. While the locking member 503 and the locking hook 140 are displaced from each other in the rotation direction, the toner cartridge 100 is mounted on the mounting portion 502 of the main body 500. When the toner cartridge 100 reaches a mounting position, the rotation power transmitting portion 552 and the rotation power receiving portion 192 face each other in the rotation direction. When the driving coupler 550 slightly rotates in the first rotation direction R1, the locking hook 140 is hooked on the locking member 503. In other words, the locking member 503 and the locking hook 140 face each other in the removal direction A2. Therefore, the toner cartridge 100 may not be moved in the removal direction A2 and may be locked in the mounting position. When the driving coupler 550 continuously rotates in the first rotation direction R1, the rotation power transmitting portion 552 pushes the rotation power receiving portion 192 in the first rotation direction R1, and the driven coupler 190 rotates in the first rotation direction R1.

The toner cartridge 100 needs to be unlocked so as to be removed from the mounting portion 502. For example, when the remaining amount of toner inside the toner cartridge 100 reaches a replacement reference amount, a replacement signal recognizable by a user may be output through an output device (not shown), for example, a display, a buzzer, a lighting device, or the like, to replace the toner cartridge 100. The replacement signal may be, for example, an image signal displayed on the display, a sound signal through the buzzer, a light signal through the lighting device, etc. The user may input an operation of requesting replacement of the toner cartridge 100 through an operation panel. A controller (not shown) may guide, for example, an operation procedure of the user for replacing the toner cartridge 100 through the display, and the user may replace the toner cartridge 100 according to a guide. To prevent arbitrary replacement of the toner cartridge 100, the operation procedure may include input of a password. The controller slightly rotates the driving coupler 550 in a second rotation direction R2, which is an opposite direction of the first rotation direction R1 according to an operation of the user. Then, the locking member 503 is unlocked from the locking hook 140, and the toner cartridge 100 is in a state in which the toner cartridge 100 may be moved in the removal direction A2.

A pop-up structure in which the toner cartridge 100 slightly pushes in the removal direction A2 after the toner cartridge 100 is unlocked may be provided on the main body 500. For example, the pop-up structure may have various structures such as an actuator and a cam structure driven in the removal direction A2, etc. After the toner cartridge 100 is unlocked, when the toner cartridge 100 is slightly pushed in the removal direction A2, the shutter 104 may be returned to the closed position.

When the toner cartridge 100 is pulled in the removal direction A2 while the toner cartridge 100 is not unlocked, the locking member 503 and/or the locking hook 140 may be broken, and the driving coupler 550, a driving portion provided in the main body 550 to drive the driving coupler 550, or the driven coupler 190 may be broken. When the locking member 503, the locking hook 140, the driving coupler 550, the driven coupler 190, etc. that are broken remain inside the main body 500, time and cost are needed to repair the image forming apparatus.

According to the toner cartridge 100 of this example, when the toner cartridge 100 is mounted on the mounting portion 502, the shutter 104 is located in the open position, and the first interference portion 122a and the second interference portion 104a remain in contact with each other. The first elastic arm 122 is maintained at a position where an amount of locking between the first coupling protrusion 121 and the first locking groove 123 decreases. In this state, even when the handle 170 is pulled in the removal direction A2 to arbitrarily remove the toner cartridge 100, because the locking member 503 of the main body 500 is locked by the locking hook 140 of the toner cartridge 100, and the toner cartridge 100 is locked by the main body 500, the toner cartridge 100 is not moved in the removal direction A2. An external force pulling the handle 170 in the removal direction A2 is applied to the first coupling protrusion 121 and the first locking groove 123. Because the amount of locking between the first coupling protrusion 121 and the first locking groove 123 decreases, when the external force increases, the first elastic arm 122 is elastically deformed to the outside and the first coupling protrusion 121 is detached from the first locking groove 123 such that the front cover 102 is separated from the housing 101. Because the handle 170 is provided on the second side wall 102b-2 of the front cover 102, the first elastic arm 122 may be easily deformed in a direction in which the first coupling protrusion 121 is detached from the first locking groove 123. According to the structure described above, while the toner cartridge 100 is locked in the main body 500, the toner cartridge 100 may be prevented from being arbitrarily removed. Also, when the front cover 102 is pulled to arbitrarily remove the toner cartridge 100, because the front cover 102 is separated from the housing 101, the locking member 503, the locking hook 140, the coupling structure, etc. may be prevented from being broken.

The decreased amount of locking between the first coupling protrusion 121 and the first locking groove 123 may be determined such that the front cover 102 is not separated from the housing 101 when the front cover 102 is pulled to remove the toner cartridge 100 while the toner cartridge 100 is unlocked from the main body 500. The decreased amount of locking between the first coupling protrusion 121 and the first locking groove 123 may be determined such that the front cover 102 is separated from the housing 101 before a locking device is broken when the front cover 102 is pulled to remove the toner cartridge 100 while the toner cartridge 100 is locked by the main body 500.

When the toner cartridge 100 is mounted on the mounting portion 502 of the main body 500, the front cover 102 may be located parallel to the entrance 502a of the mounting portion 502. In other words, the front wall 102 of the front cover 102 is aligned with the entrance 502a. The side wall 102b of the front cover 102 is inserted into the mounting portion 502. Because the handle 170 provided on the side wall 102b is not exposed to the outside, arbitrary removal of the toner cartridge 100 may be prevented.

When the user wants to remove the toner cartridge 100, the user may input, via an operation panel, an operation of requesting replacement of the toner cartridge 100. The controller (not shown) unlocks the locking member 503 from the locking hook 140 by slightly rotating the driving coupler 550 in the second rotation direction R2, which is a direction opposite to the first rotation direction R1. In this state, the toner cartridge 100 may be pulled in the removal direction A2 and removed from the main body 500. When the pop-up structure is provided, the toner cartridge 100 is unlocked and slightly pushed in the removal direction A2. Then, the handle 170 may be exposed to the outside of the mounting portion 502. Because the shutter 104 is returned to the closed position, and the first elastic arm 122 is returned to the original position, the toner cartridge 100 may be removed from the main body 500 by holding and pulling the handle 170 in the removal direction A2.

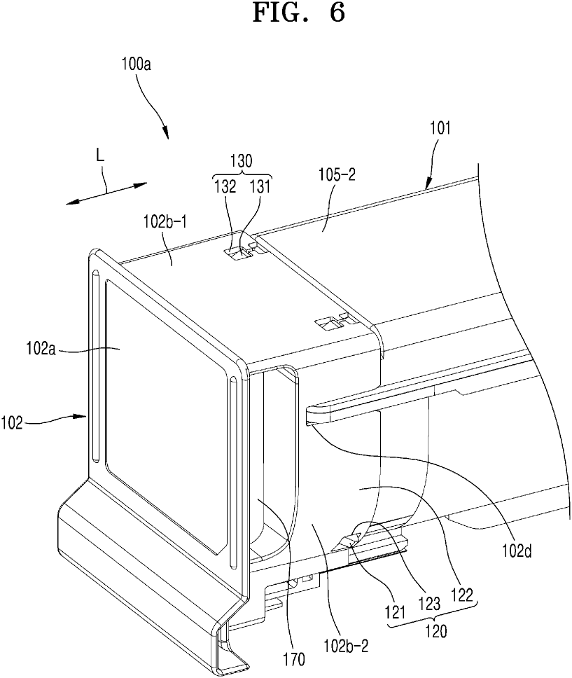

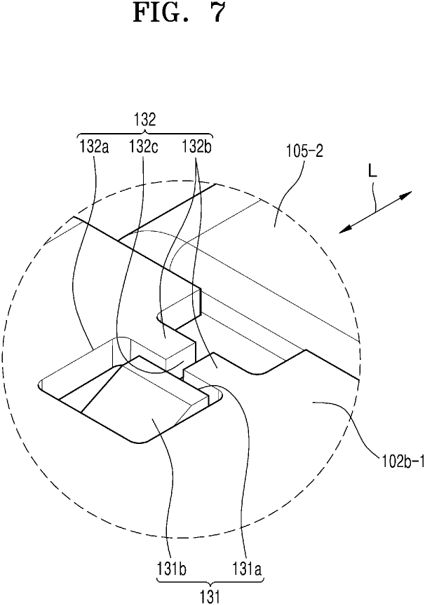

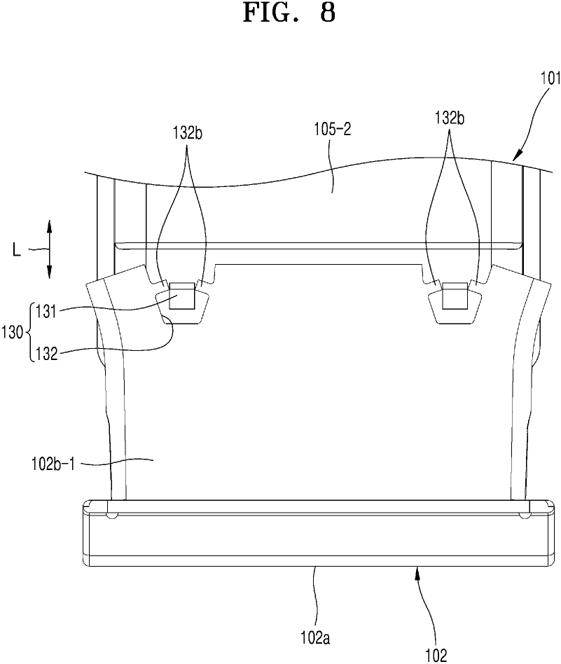

FIG. 6 is a schematic partial perspective view of an example of a toner cartridge 100a. FIG. 7 is a detailed view of a second coupling portion 130 shown in FIG. 6. FIG. 8 is a plan view of the front cover 102 separated from the housing 101 in an example of the toner cartridge 100a shown in FIG. 6. The toner cartridge 100a of the present example is different from the toner cartridge 100 described above in that the toner cartridge 100a further includes the second coupling portion 130. Differences will be mainly described below.

Referring to FIGS. 6 to 8, an example of the toner cartridge 100a may include the second coupling portion 130 elastically coupling the front cover 102 and the housing 101 on the opposite side of the toner outlet 103. The second coupling portion 130 elastically couples the first side wall 102b-1 of the front cover 102 to the housing 101. The first side wall 102b-1 of the front cover 102 faces the upper wall 105-2 of the housing 101. The second coupling portion 130 may have a snap-fit structure. According to an example, the second coupling portion 130 may include a second coupling protrusion 131 provided on the housing 101 and a second locking groove 132 provided on the first side wall 102b-1 of the front cover 102 such that the second coupling protrusion 131 is elastically locked.

The second coupling protrusion 131 may be provided on the upper wall 105-2 which is the opposite side of the lower wall 105-1 of the housing 101. The second coupling protrusion 131 may include a protruding end 131a protruding outwards from an upper wall 151-2, and an inclined portion 121b having an amount of protrusion decreasing toward the front cover 102 from the protruding end 131a. The second locking groove 132 is provided on the first side wall 102b-1 of the front cover 102. The second locking groove 132 may include an insertion groove 132a formed through the first side wall 102b-1 such that the second coupling protrusion 131 may be inserted, and a second elastic arm 132b which forms an end of the insertion groove 132a in the longitudinal direction L and by which the protruding end 131a of the second coupling protrusion 131 is locked. The second elastic arm 132b may be divided into two by a second cut groove 132c cut in the longitudinal direction L. Therefore, the second elastic arm 132b may be easily and elastically deformed compared to the case where the second cut groove 132c is not provided.

To couple the front cover 102 to the housing 101, the second coupling protrusion 131 is aligned with the second locking groove 132 and the front cover 102 is pushed in the longitudinal direction L. When the second elastic arm 132b is in contact with the inclined portion 131b of the second coupling protrusion 131, the second elastic arm 132b is elastically deformed in the upward or transverse direction. When the second coupling protrusion 131 is inserted into the second locking groove 132, the second elastic arm 132b is returned to the original position, and the protruding end 131a of the second coupling protrusion 131 is locked by the second elastic arm 132b. Thus, the front cover 102 is coupled to the housing 101.

As described above, when the shutter 104 is in an open position, an amount of locking between the first coupling protrusion 121 and the first locking groove 123 may decrease. In this case, when the front cover 102 is pulled in the removal direction A2 while the toner cartridge 100a is not unlocked, as described above, the first elastic arm 122 is elastically deformed outwards, and the first coupling protrusion 121 may be detached from the first locking groove 123. Thus, a user may stop an arbitrary removal operation of the toner cartridge 100a. In this state, when the front cover 102 is further pulled in the removal direction A2, the second elastic arm 132b is elastically deformed as shown in FIG. 8, and the second coupling protrusion 131 is detached from the second locking groove 132 such that the front cover 102 is separated from the housing 101. When the second cut groove 132c is formed in the second elastic arm 132b, the second elastic arm 132b is elastically deformed more easily such that the second coupling protrusion 131 may be easily detached from the second locking groove 132. The size and shape of the second elastic arm 132b may be determined such that the front cover 102 is separated from the housing 101 before a locking device is broken when the front cover 102 is pulled to remove the toner cartridge 100a while the toner cartridge 100a is locked by the main body 500. Therefore, while the toner cartridge 100a is locked by the main body 500, arbitrary removal of the toner cartridge 100a may be prevented, and the locking member 503, the locking hook 140, a coupling structure, etc. may be prevented from being broken.

When the shutter 104 is in the open position, the first coupling protrusion 121 and the first locking groove 123 may be unlocked. In this case, when the front cover 102 is pulled in the removal direction A2 while the toner cartridge 100a is not unlocked, the second elastic arm 132b is elastically deformed as shown in FIG. 8, and the second coupling protrusion 131 is detached from the second locking groove 132 such that the front cover 102 is separated from the housing 101. Accordingly, arbitrary removal of the toner cartridge 100a and the locking member 503, the locking hook 140, the coupling structure, etc, may be prevented from being broken.

When the shutter 104 is in the open position, and the first coupling protrusion 121 and the first locking groove 123 are unlocked, a normal removal operation in which the toner cartridge 100a is unlocked may be performed. In this case, because the second coupling protrusion 131 is locked by the second locking groove 132, even when the front cover 102 is pulled in the removal direction A2, the front cover 102 is not separated from the housing 101, and the toner cartridge 100a is moved in the removal direction A2. The size and shape of the second elastic arm 132b may be determined such that the front cover 102 is not separated from the housing 101 when the front cover 102 is pulled to remove the toner cartridge 100a while the toner cartridge 100a is unlocked by the main body 500. When the toner cartridge 100a comes out slightly in the removal direction A2, the shutter 104 is moved from the open position to the closed position, and the first coupling protrusion 121 is locked by the first locking groove 123. Subsequently, the toner cartridge 100a may be removed from the main body 500 by pulling the front cover 102 in the removal direction A2.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

1. A toner cartridge comprising:
a housing to contain toner and comprising a toner outlet adjacent to a front end in a longitudinal direction;
a front cover coupled to the front end of the housing;
a first coupling portion to couple the front cover to the housing based on a coupling force of the first coupling portion; and
a shutter movable between an open position and a closed position to open and close the toner outlet, and to weaken the coupling force of the first coupling portion when the shutter is moved from the closed position to the open position.

2. The toner cartridge of claim 1, wherein the first coupling portion comprises:
a first elastic arm on the front cover;
a first coupling protrusion on one of the housing and the first elastic arm; and
a first locking groove in the other one of the housing and the first elastic arm by which the first coupling protrusion is to be locked,
wherein, when the shutter moves from the closed position to the open position, the shutter deforms the first elastic arm in a direction such that an amount of locking between the first coupling protrusion and the first locking groove decreases.

3. The toner cartridge of claim 2, wherein, when the shutter is in the open position, the first coupling protrusion is unlocked from the first locking groove.

4. The toner cartridge of claim 2, further comprising:
a first interference portion on the first elastic arm; and
a second interference portion on the shutter and having a shape in which an amount of interference with the first interference portion gradually increases as the shutter is moved to the open position.

5. The toner cartridge of claim 2, wherein the toner outlet is on a lower wall of the housing,
wherein the front cover comprises a front wall facing the front end of the housing, and
wherein the first elastic arm extends from the front wall toward the front end of the housing.

6. The toner cartridge of claim 5, wherein the front cover comprises a side wall extending from the front wall toward the front end of the housing,
wherein the side wall comprises a first side wall located on an opposite side of the lower wall and a second side wall located on a traverse direction side, and
wherein a first cut groove in the second side wall extends from the end facing the housing toward the front wall, and a part of the second side wall to function as the first elastic arm.

7. The toner cartridge of claim 6, wherein a handle is on the second side wall.

8. The toner cartridge of claim 6, further comprising a second coupling portion to elastically couple the front cover to the housing in an opposite side of the toner outlet.

9. The toner cartridge of claim 8, wherein the second coupling portion comprises:
a second coupling protrusion on the housing; and
a second locking groove in the first side wall such that the second coupling protrusion is elastically locked.

10. The toner cartridge of claim 9, wherein the second coupling protrusion comprises a protruding end protruding from the housing, and an inclined portion having an amount of protrusion decreasing toward the front cover from the protruding end,
wherein the second locking groove comprises an insertion groove into which the second coupling protrusion is inserted, and a second elastic arm to form an end of the insertion groove in the longitudinal direction and by which the protruding end of the second coupling protrusion is locked, and
wherein the second elastic arm is divided into two by a second cut groove in the longitudinal direction.

11. A toner cartridge comprising:
a housing to contain toner and comprising a lower wall, an upper wall, a toner outlet on the lower wall, and a first coupling protrusion protruding from the lower wall;
a front cover coupled to a front end of the housing in a longitudinal direction and comprising a first elastic arm, a first locking groove in the first elastic arm by which the first coupling protrusion is to be locked, and a handle; and
a shutter in the housing and movable to an open position and a closed position to open and close the toner outlet, and, when the shutter moves from the closed position to the open position, to deform the first elastic arm in a direction such that an amount of locking between the first coupling protrusion and the first locking groove decreases.

12. The toner cartridge of claim 11, further comprising:
a first interference portion on the first elastic arm; and
a second interference portion on the shutter and having a shape in which an amount of interference with the first interference portion gradually increases as the shutter moves to the open position.

13. The toner cartridge of claim 12, further comprising:
a second coupling protrusion on the upper wall; and
a second locking groove in the front cover such that the second coupling protrusion is elastically locked.

14. The toner cartridge of claim 13, wherein the second coupling protrusion comprises a protruding end protruding from the upper wall, and an inclined portion having an amount of protrusion decreasing toward the front cover from the protruding end,
wherein the second locking groove comprises an insertion groove into which the second coupling protrusion is inserted, and a second elastic arm to form an end of the insertion groove in the longitudinal direction and by which the protruding end of the second coupling protrusion is locked, and
wherein the second elastic arm is divided into two by a second cut groove in the longitudinal direction.

15. A toner cartridge comprising:
a housing to contain toner and comprising a toner outlet adjacent to a front end in a longitudinal direction;
a front cover elastically coupled to the front end of the housing based on an elastic coupling force of the front cover; and
a shutter movable to an open position and a closed position to open and close the toner outlet, and to weaken the elastic coupling force of the front cover when the shutter is moved from the closed position to the open position.
